(19) United States
(12) Patent Application Publication
(10) Pub. No.: US 2015/0324941 A1
(43) Pub. Date: Nov. 12, 2015

(54) SYSTEM AND METHOD FOR RANKING REAL ESTATE PROPERTY LISTINGS

(71) Applicant: WALL2WALL MEDIA INC., Verdun (CA)

(72) Inventor: Mohit Garg, Mississauga (CA)

(21) Appl. No.: 14/707,854

(22) Filed: May 8, 2015

Related U.S. Application Data
(60) Provisional application No. 61/990,393, filed on May 8, 2014.

(51) Int. Cl. G06Q 50/16; G06Q 30/06

(52) U.S. Cl. CPC G06Q 50/16; G06Q 30/06

(57) ABSTRACT

A method and system is provided for ranking real estate property listings. Listings representing real estate properties are stored in memory, together with demography profiles, each representing a group of demography, and amenity types. Each listing is associated to listing amenities representing amenities present in proximity to the real estate property and each demography profile is associated to desired amenities representing amenities desired by the corresponding group of demography. A ranking value is then calculated for each listing, on the basis of a correspondence between the desired amenities of the demography profile and the listing amenities associated to the listing, in order to rank the listings for the corresponding group of demography.

### FIELD

The present invention relates to the field of online real estate listing directories.

### BACKGROUND

Consumers consider various factors in the decision making process of a real estate purchase or rental. These factors include neighbourhood information, nearby amenities, distance from work to educational institutions, their ranking and other lifestyle needs. Although some of this information may be available to varying degrees and in varying sources, it is challenging for the consumer to consolidate all these factors into a comprehensive and comparable manner. Also, depending on the lifestyle of the consumer, each of these factors may weigh differently, for example depending on the stage of life they are living in.

In light of the above, there is a need for an improved system and method for gathering and processing the numerous factors involved in the decision making processor of a real estate purchase or rental, in accordance with a consumer's lifestyle needs.

### SUMMARY

An object of the present invention is to provide an improved system and method of ranking a real estate property or area based on the lifestyle preferences of various demographic groups.

In accordance with an aspect, there is provided a method for ranking real estate property listings, the method comprising:
a) providing in a memory:
   listings, each representing a real estate property;
   demography profiles, each representing a group of demography; and
   amenity types;
wherein each listing is associated to one or more listing amenity selected among said amenity types, representing amenities present in proximity to the real estate property and wherein each demography profile is associated to one or more desired amenity selected among said amenity types representing amenities desired by the corresponding group of demography; and
b) calculating for one of said demography profiles, by means of a processor, a ranking value for each listing, on the basis of a correspondence between the one or more desired amenity of the demography profile and the one or more listing amenity associated to the listing, in order to rank said listings for the corresponding group of demography.

The demography profiles provided may comprise: a student profile, a young professional profile, a family-oriented profile and/or an empty nester profile. According to a particular embodiment, the calculating of step (b) is executed for other one or more of said demography profiles.

According to an embodiment, each of said one or more desired amenity in step (a) is associated to an importance indicia (for example High importance indicia, Moderate importance indicia and Low importance indicia) for a given one of said demography profiles. The importance indicia represents a level of importance of the desired amenity for the corresponding group of demography. In such embodiment, the ranking value of each result listing is calculated in step (b) based on the importance indicia of the desired amenity associated to each listing amenity.

According to an embodiment, the ranking value is calculated for each result listing by: assigning to the result listing, a score for each listing amenity; and aggregating the scores on the basis of said importance indicia of the corresponding desired amenity, to determine the ranking value.

The score for one of said listing amenity may be determined according to an amenity distance. The amenity distance may correspond to the distance between a geographical location of an instance of said amenity type of the corresponding listing amenity and a location of the real estate property. The instance may correspond to a nearest instance of said amenity type. Alternatively, amenity distance may correspond to an average of distances between a location of the real estate property and multiple instances, respectively, of said amenity type of the corresponding listing amenity. The score may be assigned by providing distance brackets and associating a numerical score to each of said distance bracket; and selecting the numerical score associated to the distance bracket which corresponds to said amenity distance

The aggregating step may comprise associating a weight to the score of each listing amenity, on the basis of the importance indicia associated to the corresponding desired amenity. In addition, a human factor multiplier may be further combined to obtain the ranking value. Furthermore, a neighborhood influencer may be further combined to obtain the ranking value.

According to an embodiment, each ranking value is stored in the memory in association with the corresponding listing and the corresponding demography profile. Depending on embodiments, the ranking values may be pre-calculated or dynamically calculated upon executing a search query.

Upon the launch of a query, the processor receives, via an input port, a selected demography profile corresponding to a selection among said demography profiles, and a search query. The processor returns, by means of a search engine, result listings representing listings stored in the memory, which correspond to the search query. A ranking module, ranks the result listings based on the ranking values of the respective result listings. A selection module selects result listings to be output as output listings. For example, result listings having a ranking value which is greater or equal to a ranking threshold may be selected. The output listings are then sent via an output port, to be presented in accordance to said ranking, for example in a list, sorted according to the ranking value of each selected listing and/or in a map.

According to another aspect, there is provided a non-transitory processor-readable storage medium for ranking real estate property listings, which comprises data and instructions for execution by a processor, to execute the steps of the method described herein.

According to yet another aspect, there is provided a system for ranking real estate property listings. The system comprises a memory for storing: listings, each representing a real estate property; demography profiles, each representing a group of demography; and amenity types; wherein each listing and being is associated to one or more listing amenity selected among said amenity types, representing amenities present in proximity to the real estate property and wherein each demography profile is associated to one or more desired amenity selected among said amenity types representing amenities desired by the corresponding group of demography; and a processor for calculating a ranking value for each listing, for one of said demography profiles, on the basis of a correspondence between the one or more desired amenity of the demography profile and the one or more listing amenity associated to the listing, in order to rank said listings for the corresponding group of demography.

In accordance with an embodiment, there is provided a method of ranking a real estate element for a particular group of demography, the method comprising: providing in a memory, a list of amenities, each amenity being associated to an importance indicia representing a level of importance of said amenity for the particular group of demography; assigning, by means of a processor, a score for each amenity representing a presence of said amenity in proximity to the real estate element; calculating, by means of the processor, a ranking value by aggregating the scores based on said importance indicia; and storing in the memory, the ranking value in association with the real estate element. Preferably the method further comprises displaying on a display screen, said real estate element based on the associated ranking value. The ranking value or a representation of the ranking value may further be displayed on the display screen in association with the real estate element. Preferably the method is performed for various groups of demography.

A real estate element may be for example, a real estate property or a region such as a neighborhood.

The score assigned to each amenity may be based on a distance of a nearest amenity for a given category of amenities, on an average distance of amenities of a given category, on a number of amenities of a particular category, and/or the like.

In accordance with another embodiment, there is provided a computer implemented method of ranking a real estate element for a particular group of demography, the method comprising: calculating by means of a processor, a ranking value based on a presence of amenities in proximity to the real estate element, and a level of importance of each of said amenities for the particular group of demography; and storing in a memory, the ranking value in association with the real estate element.

In accordance with another embodiment, there is provided a system for ranking a real estate element for a particular group of demography, the system comprising: a memory for storing a list of amenities, each amenity being associated to an importance indicia representing a level of importance of said amenity for the particular group of demography; and a processor being in communication with the memory, for assigning a score for each amenity representing a presence of said amenity in proximity to the real estate element, for calculating a ranking value by aggregating the scores based on said importance indicia, and for storing in the memory, the ranking value in association with the real estate element. In a particular embodiment, the system further comprises a display screen for displaying said ranking value in association with the real estate element.

The objects, advantages and features of the present invention will become more apparent upon reading of the following non-restrictive description of preferred embodiments thereof, given for the purpose of exemplification only, with reference to the accompanying drawings.

### BRIEF DESCRIPTION OF THE DRAWINGS

FIG. 1 is a schematic representation of a ranking system for real estate properties, according to an embodiment of the present invention.

FIG. 2 is a bloc diagram showing steps executed by the system shown in FIG. 1.

FIG. 3 shows a table listing various amenity categories and their importance level for each lifestyle group, in accordance with an embodiment.

FIG. 4 shows a table listing ranges of distances of a given amenity from a property of interest, and associated score values.

FIG. 5 shows a table listing amenities with high importance for young professionals.

FIG. 6 shows a table outlining a list of amenity categories 62 with corresponding importance indicia.

FIG. 7 is a screenshot of a user interface of a smart phone application, in accordance with an embodiment.

FIG. 8 is another screenshot of a user interface of a smart phone application, in accordance with an embodiment.

FIG. 9 is another screenshot of a user interface of a smart phone application, in accordance with an embodiment.

FIG. 10 is another screenshot of a user interface of a smart phone application, in accordance with an embodiment.

FIG. 11 is another screenshot of a user interface of a smart phone application, in accordance with an embodiment.

FIG. 12 is another screenshot of a user interface of a smart phone application, in accordance with an embodiment.

FIG. 13 is another screenshot of a user interface of a smart phone application, in accordance with an embodiment.

FIG. 14 is a screenshot of a user interface of a desktop computer application.

FIG. 15 is another screenshot of a user interface of a desktop computer application.

FIG. 16 shows a table listing various neighborhood-related influencers and their importance level (or influence level) for each lifestyle group, in accordance with an embodiment.

FIG. 17 shows a table listing the neighborhood-related influencers shown in FIG. 16, with weights and calculations for particular lifestyle groups.

### DETAILED DESCRIPTION OF PREFERRED EMBODIMENTS

In the following description, the same numerical references refer to similar elements. The embodiments mentioned and/or geometrical configurations and dimensions shown in the figures or described in the present description are embodiments of the present invention only, given for exemplification purposes only.

Broadly, in accordance with an embodiment, there is provided a ranking system for ranking real estate properties based on lifestyles needs of different groups of purchasers.

Categories of consumers (or “group of demography”) are generally defined as follows:
Young Professional: looking for happening space in urban place.
Student: looking for shared place or study space.
Empty Nesters: looking for fun place in an exciting space.
Family Oriented: looking for a convenient place with lots of space.

The above categories of consumers are also referred to herein as “demography profiles”, “group of demography” or “lifestyle group” or the like.

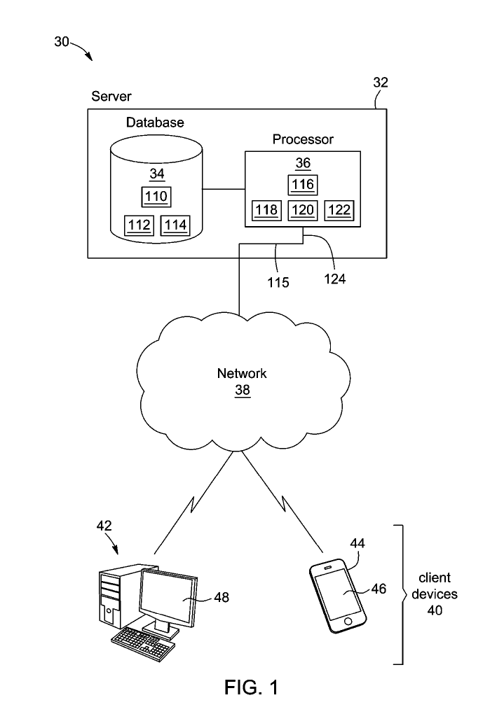

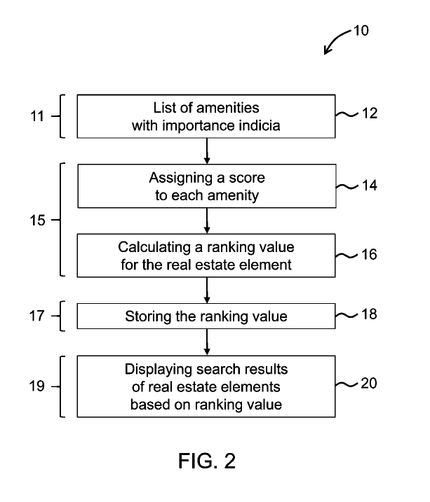

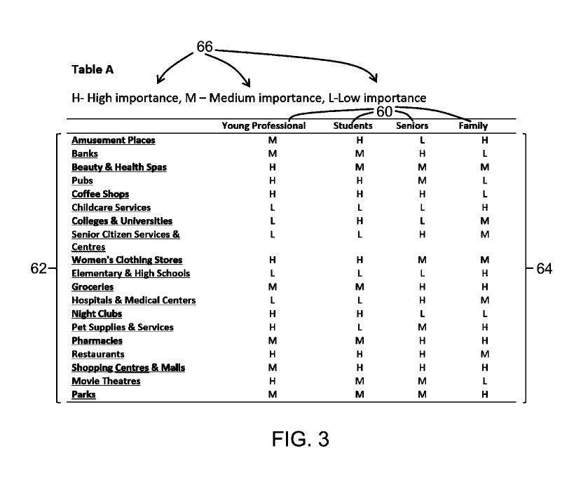

Thus, as better illustrated in FIGS. 1 and 2, there is provided a computer-implemented method 10 of ranking a real estate property for various groups of demography 62 (see FIG. 3). The method is executed by a system 30 comprising a server system 32 having a database 34 and a processor 36. The system 30 further comprises a client device 40 which is adapted to communicate with the server 32 via a communication network 38. The processor includes, in input port 115, a calculator 116, a search engine 118, a ranking module 120, a selection module 122 and an output port 124.

With further reference to FIG. 3, the method 10 comprises (at step 12) providing in a memory: listings 110, demography profiles 112 and amenity types 114. Each listing 110 represents a real estate property, and each demography profile 112 represents a group of demography 60. Each listing is associated to one or more listing amenity selected among said amenity types 114, representing amenities present in proximity to the real estate property. That is to say, the listing amenities represent amenities located within a radius of the location of the real estate property. The radius considered may depend on the particular amenity type. Other restrictions may be given (for example accessibility, etc.) as to whether an instance of an amenity is considered to be “in proximity” to the real estate property. Furthermore, each demography profile is associated to one or more desired amenity selected among said amenity types representing amenities desired by the corresponding group of demography.

Thus, there is provided 11 in a memory, namely in database 34, a list of amenities 62, each amenity being associated to an importance indicia 64 representing a level of importance 66 of the amenity 62 for the particular group of demography 62. Thus, as shown in the table of FIG. 3, the various amenities 62 and their importance 64 are predefined for each lifestyle group 60. For example, it is of high importance for a family to find a home close to a school, parks and daycares while for a young professional, it is more important to find a place to live around coffee shops, restaurants and shopping areas.

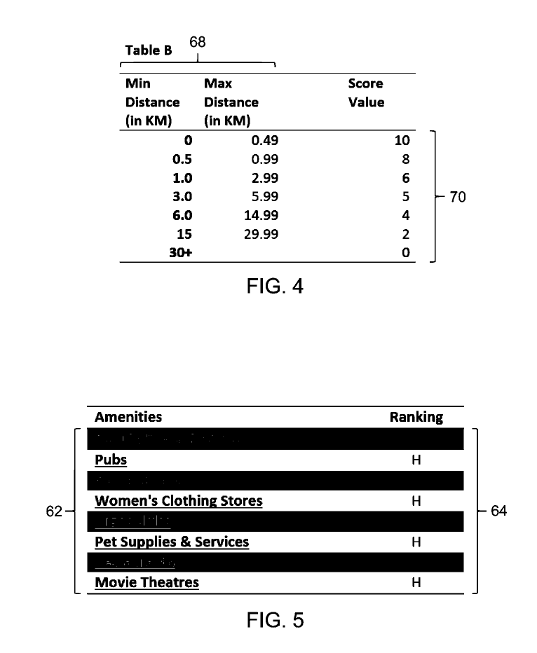

With further reference to FIG. 4, a score is then assigned for each amenity at step 14, for a given real estate property. The score represents a presence of the amenity 62 in proximity to the real estate property. More particularly, the score is determined depending on a distance of the amenity 62 having the nearest location to the real estate property. FIG. 4 shows ranges of distances 68 (or “distance brackets”) and associated score values 70 (or “numerical score”). Thus, a weight is associated to the score of each listing amenity, on the basis of the importance indicia associated to the corresponding desired amenity (i.e. associated to the same amenity type as the listing amenity). This information is previously defined and stored in the database 34 (see FIG. 1). Alternatively, this information (either in part or in totality) may be obtained or updated dynamically.

It is to be understood that in accordance with alternate embodiments, the score may take into account the number of instances for each amenity category within a given radius about the property, an average distance of all the instances for a given category of amenities, accessibility to the amenities, and/or the like.

It will be appreciated also that the score for different amenity types may be calculated differently.

Referring back to the illustrated embodiment, the scores attributed to a particular real estate property are then aggregated at step 16, in order to calculate a ranking value taking into account the previously assigned importance indicia 64, as well as a “human factor” given to a real estate property by experts and/or property owners.

Thus, the method includes calculating 15, for each demography profile 112, by means of the processor 36, a ranking value for each listing 110, on the basis of a correspondence between the one or more desired amenity of the demography profile 112 and the one or more listing amenity associated to the listing, in order to rank said listings 110 for the corresponding group of demography 62.

In addition a human factor multiplier and/or a neighborhood influencer multiplier may be combined in order to obtain the ranking value.

More particularly, the following formula is applied:
Ranking value=
   Math.Round (Average of High importance indicia scores
   +Average of Moderate importance indicia scores×0.1
   +Average of Low importance indicia scores×0.01, 2)
   x Human Factor
   x Neighbourhood Influencer
where Human Factor is an average of ranking given by area experts and Neighbourhood Influencer is a multiplier based on demographic and real estate.

A Human Factor is a multiplier which adjusts the ranking value, when such an adjustment is deemed appropriate. The default value of the Human Factor is 1 (i.e. no adjustment). However, when factors additional to those taken into consideration by the scores influence the likelihood that a particular real estate property is suitable for a group of demography, the Human Factor provides additional adjustment to reflect such factors. Such factors may include for example, crime rate, traffic level in surrounding roads, constructions, etc. The human factor may be established automatically, for example by entering additional information in the system database, or entered manually for each listing or a group of listing in a particular area, based on feedback from residents of the location, real estate experts, and/or the like.

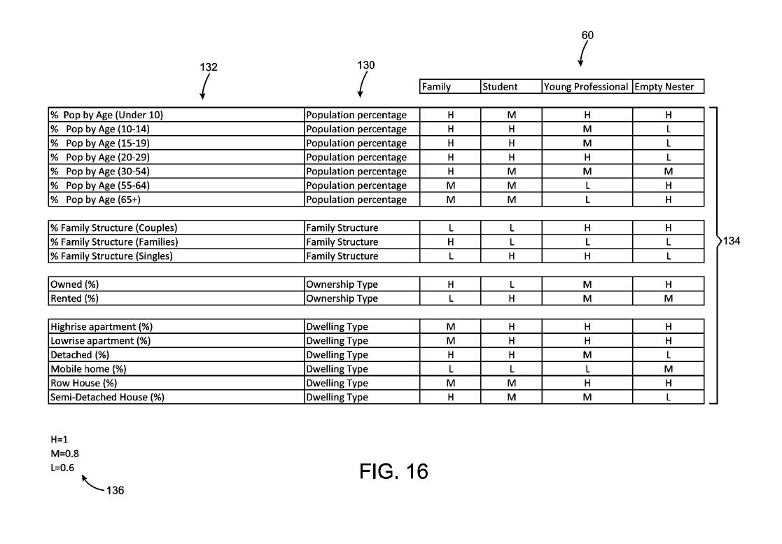

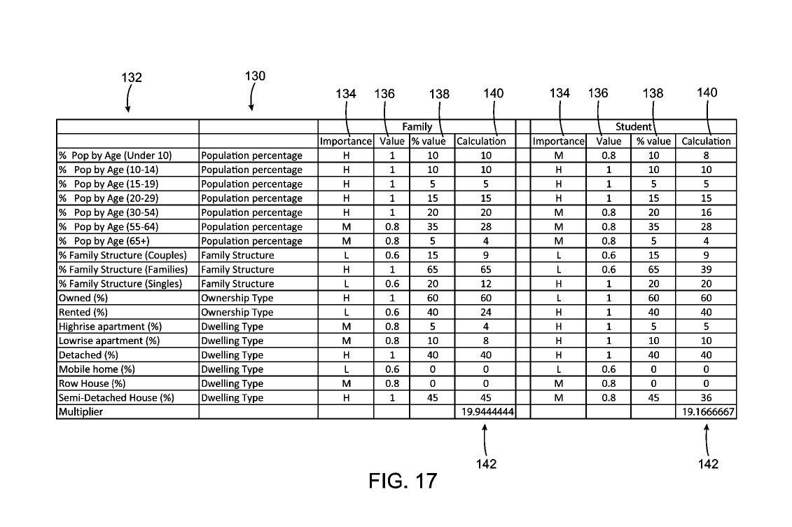

A neighborhood influencer provides an additional adjustment to obtain the ranking value of a particular listing. The neighborhood influencer based on statistics on the current demography of a neighborhood. Such statistics are exemplified in FIGS. 16 and 17.

FIG. 16 shows a table listing various neighborhood-related influencing factors 130 and particular segments 132 of the influencing factors 130. The importance level 134 (or influence level) is further given for each segment 132 and for each demographic profile 60.

FIG. 17 shows a table listing the neighborhood-related influencers shown in FIG. 16, with weights and calculations for the particular cases of a family-oriented demography profile and a student profile. An importance value 136 is attributed to each segment 132 depending on the level of importance (H, M, L) for the particular demographic profile. The importance value 136 is further multiplied by a weight 138 which represents an influence level of the segment for the group of demography. The results 140 are averaged which provides (at 142) the Neighbourhood Influencer for each group, to be inserted in the above-formulae to obtained the ranking value.

Alternatively, the following formula may be applied, in another embodiment:
Ranking value=
   Math.Round (Average of High Score Value for one Building
   +Average of Moderate Score Value for one Building*0.1
   +Average of Low Score Value for one Building*0.01, 2)*Human Factor
Where Human Factor is the average of ranking given by area experts on a scale of (0, 0.1, 0.2, 0.3 . . . to 1.0).

Thus, in this embodiment, a maximum result if 10.11 may be obtained as follows for any property:

Max Result=Round (10+10*0.1+10*0.01, 2)*1=10.11

At step 18 (or step 17), the ranking values calculated for each group of demography is stored in the database 34 in association with each real estate property.

### EXAMPLE

The above-described method will now be described in the context of an example.

The real estate property is a 1-bedroom unit available at 123 Front Street, Toronto ON and the targeted group of demography is the “young professional” group.

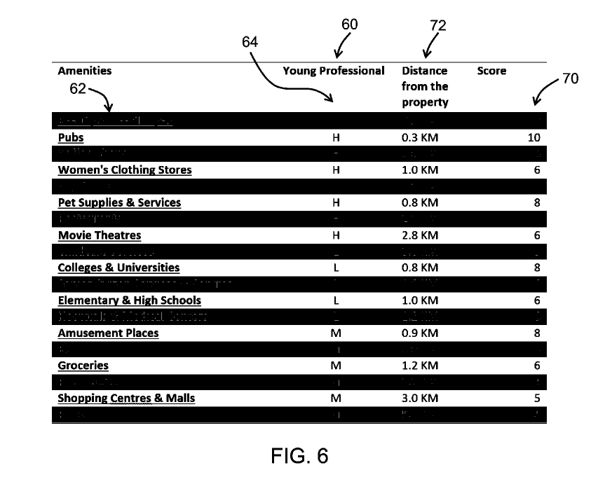

Amenities with high importance for young professionals are shown in FIG. 5. A table outlining the complete list of amenity categories 62 with corresponding importance indicia 60 is shown in FIG. 6. The table further outlines for each amenity category 62, a distance 72 of the nearest location of the amenity category and corresponding score 70 attributed based on the ranges defined in FIG. 4.

The calculation of the ranking value is then calculated as follows:
Average of Amenities of high importance=7.5
Average of Amenities of Medium importance=6.3
Average of Amenities of Low importance=6.2
A Human Factor of 0.8 is given by property owner for young professional and a neighbourhood expert.

$$Ranking Value = Math . Round ( Average of High Score Value for one Building + Average of Moderate Score Value for one Building * 0.1 + Average of Low Score Value for one Building * 0.01 , 2 ) * Human Factor$$

$$\begin{matrix}Ranking Value = ( 7.5 + 6.3 * 0.1 + 6.2 * 0.01 ) * 0.8 \\ = ( 7.5 + 0.63 + 0.06 ) * 0.8 \\ = 8.19 * 0.8 \\ = 6.5\end{matrix}$$

This ranking value indicates that when a young professional is likely to find this property moderately suitable to his/her needs and that he/she should be able to find homes that are more suitable to his/her lifestyle needs.

System Architecture

As previously mentioned, the system 30 is provided by a client-server architecture on a web-based platform, as better illustrated in FIG. 1.

The server 32 is provided by a general purpose computer device. It is to be understood that the server 32 may be provided by any other suitable computer device, in accordance with alternate embodiments. It is to be understood also that the server may be provided by a plurality of such computer devices, which are in communication with one another and may be adapted to cooperate together in order to provide the previously mentioned functional modules. The server is connected to a client-side device 40, via communication network 38.

The client 40 is also provided by a computer device, such as a conventional computer 42, a smart phone 44 and/or other any suitable computer device(s), such as a tablet computer for example. The client 40 provides a user interface 46, 48, via a web browser or web-based application, in accordance with the embodiment described herein. For example, the user interface may be accessible via a website (for conventional computers) or via a dedicated application on a tablet computer or smartphone.

In accordance with the present embodiment, the data communication network 38 is provided by the Internet. In alternative embodiments, the data communication network may be provided by any suitable communication network, such as cellular wireless network and conventional telephone (“land line”) network, and/or other.

User Interface

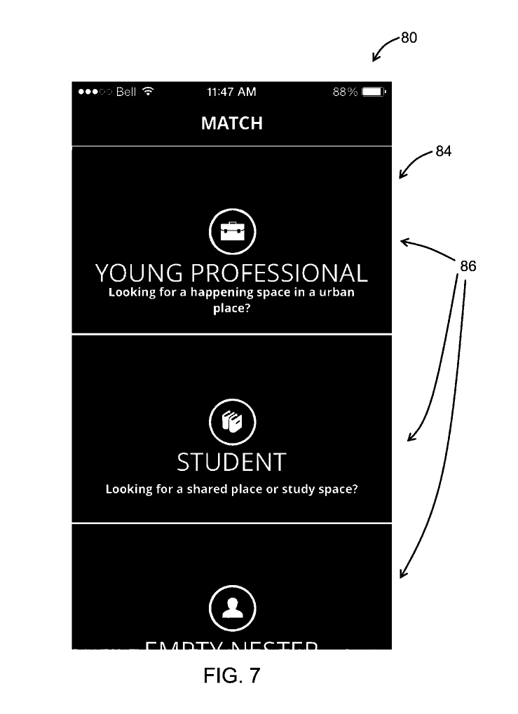

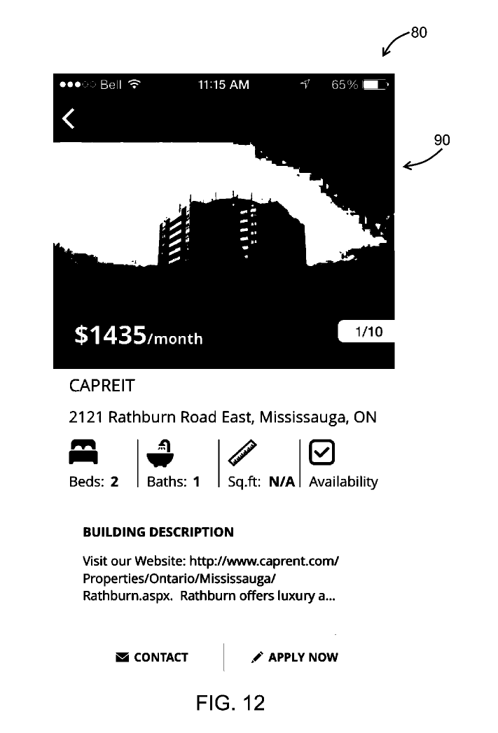

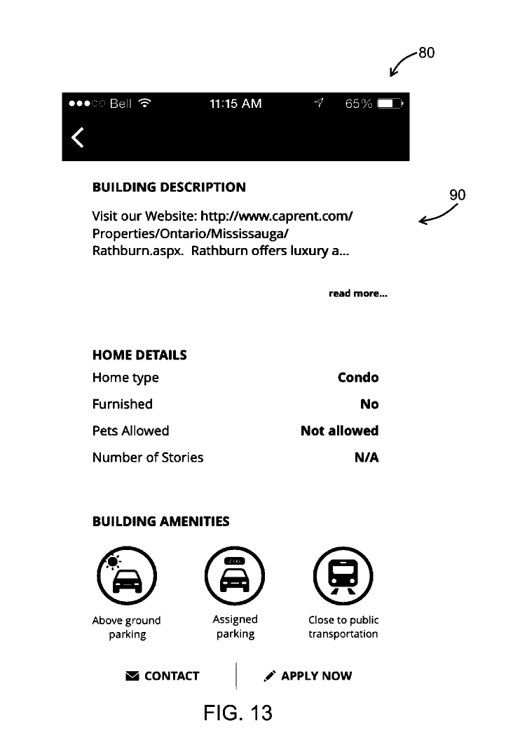

FIGS. 7 to 13 show screens 80 of a user interface 46 on a smart phone 44 application (see FIG. 1).

Referring to FIG. 7, upon launching the client application, the user interface displays 80, a scrollable menu 84 including the lifestyle group options 86 to choose from (corresponding to demographic profiles 112—in FIG. 1).

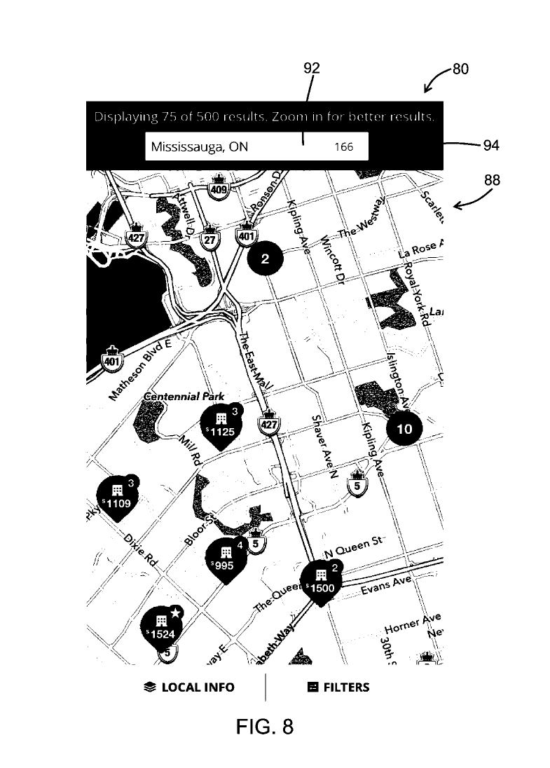

Upon choosing a particular lifestyle group 86, the system 30 retrieves the location of the smart phone application using geo-location capabilities of the smart phone 44 and displays a map 88 showing property listings in the area surrounding this location, as exemplified in FIG. 8. A search field 92 displays the identified location by default, and further allows a user to enter a different location to search from if desired. Furthermore, a list button 94 allows a user to view the search results in a list format.

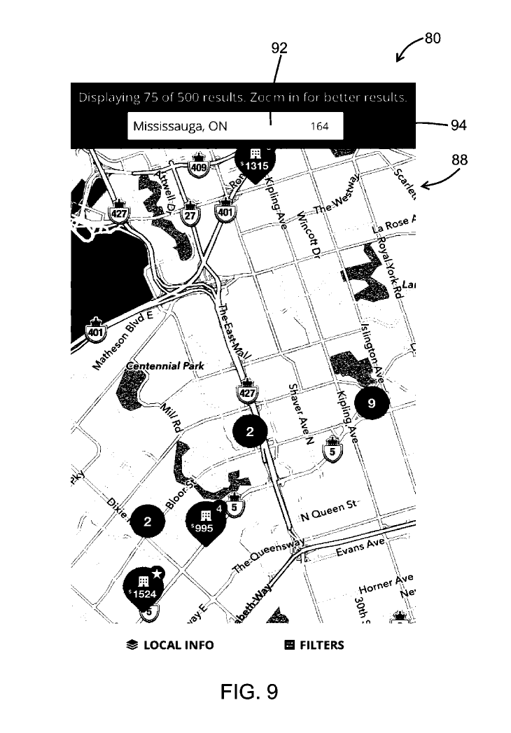

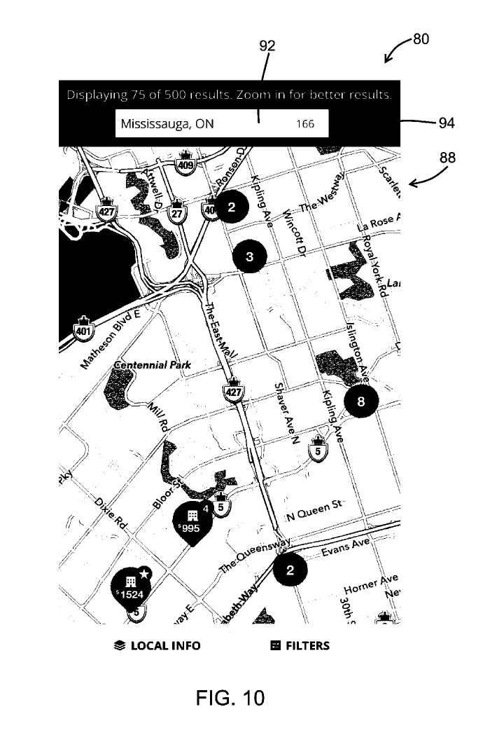

FIG. 8 shows property listings in a map format 88 for a user having chosen the ‘young professional’ group. FIG. 9 shows property listings in a map format 88 for a user having chosen the ‘student’ group. FIG. 10 shows property listings in a map format 88 for a user having chosen the ‘empty nester’ group.

Depending on the lifestyle group having been chosen, the results show only the properties having a ranking value greater than 4 for the chosen lifestyle group.

Thus, the method provides, with further reference to FIGS. 1 and 2, receiving at the processor 36, a selected demography profile 86 corresponding to a selection among said demography profiles 112, and a search query. The search query may include various search parameters or filters for the searched property, for example, a cost bracket, a property size, number of rooms, the type of property, the presence of a garage, etc. The search engine 118 returns result listings representing listings 110 stored in the memory (for example in database 34), which correspond to the search query. The ranking module 120 ranks the result listings based on the ranking values of the result listings. It is to be understood that the ranking module may trigger the calculator to calculate the necessary ranking values. The selection module 122 further selects result listings to be output as output listings (for example filtering based on the ranking value), which are sent via the output port 124 to be presented (step 19) in accordance to said ranking, for example in a list, sorted according to the ranking value of each selected listing, and/or in a map on the client device 42, 44.

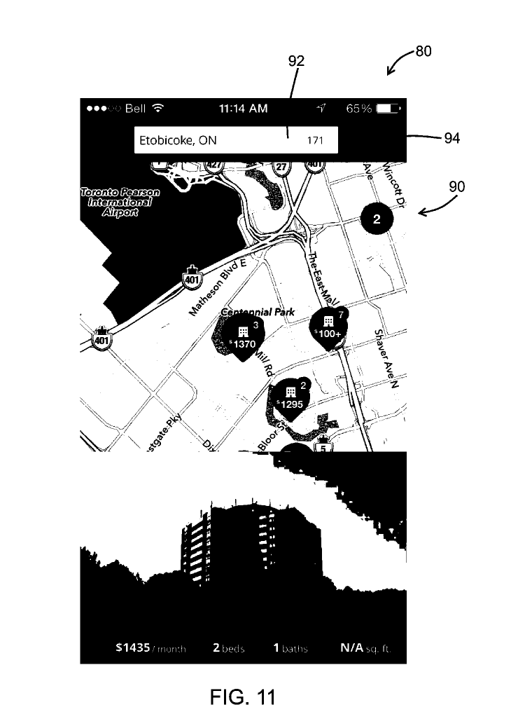

FIGS. 11 to 13 show different segments of a scrollable display 90 providing information on a selected one of the property listings of the search results.

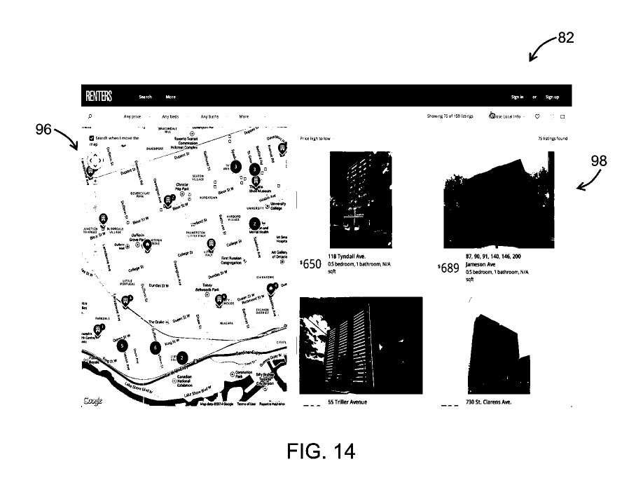

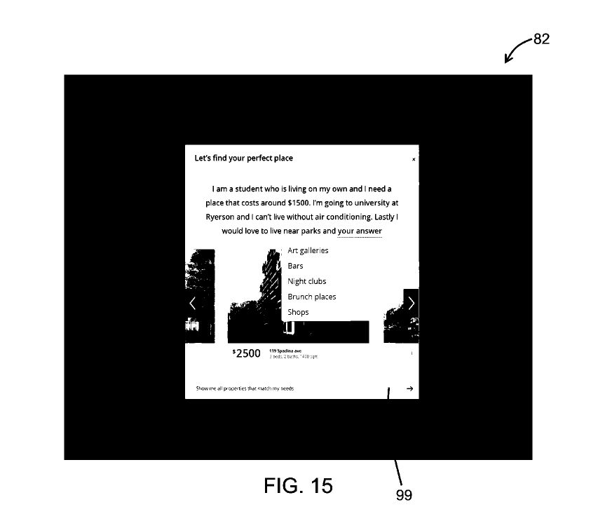

FIGS. 14 and 15 show screens 82 displayed on a user interface 48 of a desktop computer 42 (see FIG. 1). Namely, FIG. 14 shows search results in both map format 96 and list format 98. FIG. 15 shows a search window 99 allowing a user to enter real estate search criteria in an intuitive manner.

Although in the illustrated embodiment, the ranking value is not specifically displayed to the user, it is to be understood that in alternate embodiments, this ranking value or a corresponding indicator (for example in a 5 star system) may be displayed in either the overall result screen and/or in a more detailed screen showing the information associated to a particular property.

It is to be understood also that a similar ranking value may be calculated for a neighborhood or otherwise geographically defined area.

It is to be understood also, that in accordance with alternate embodiments, the calculation of the ranking value may take into account additional information, for example statistical data on the demographics, on crime rate, and/or the like associated to a an area or city.

The above-described embodiments are considered in all respect only as illustrative and not restrictive, and the present application is intended to cover any adaptations or variations thereof, as apparent to a person skilled in the art. Of course, numerous other modifications could be made to the above-described embodiments without departing from the scope of the invention, as apparent to a person skilled in the art.

1. A method for ranking real estate property listings, the method comprising:
a) providing in a memory:
listings, each representing a real estate property;
demography profiles, each representing a group of demography; and
amenity types;
wherein each listing is associated to one or more listing amenity selected among said amenity types, representing amenities present in proximity to the real estate property and wherein each demography profile is associated to one or more desired amenity selected among said amenity types representing amenities desired by the corresponding group of demography; and
b) calculating for one of said demography profiles, by means of a calculator integrated in a processor, a ranking value for each listing, on the basis of a correspondence between the one or more desired amenity of the demography profile and the one or more listing amenity associated to the listing, in order to rank said listings for the corresponding group of demography.

2. The method according to claim 1, wherein said calculating of step (b) is executed for other one or more of said demography profiles.

3. The method according to claim 1, wherein the demography profiles provided in step (a) comprise at least one of: a student profile, a young professional profile, a family-oriented profile and an empty nester profile.

4. The method according to claim 1, wherein:
each of said one or more desired amenity in step (a) is associated to an importance indicia for a given one of said demography profiles, the importance indicia representing a level of importance of said desired amenity for the corresponding group of demography; and
the ranking value of each result listing is calculated in step (b) based on the importance indicia of the desired amenity associated to each listing amenity.

5. The method according to claim 4, wherein said calculating the ranking value for each result listing, further comprises:
assigning to the result listing, a score for each listing amenity; and
aggregating the scores on the basis of said importance indicia of the corresponding desired amenity, to determine the ranking value.

6. The method according to claim 5, wherein the score for one of said listing amenity is determined according to an amenity distance.

7. The method according to claim 6, wherein the amenity distance corresponds to the distance between a geographical location of an instance of said amenity type of the corresponding listing amenity and a location of the real estate property.

8. The method according to claim 7, wherein the instance corresponds to a nearest instance of said amenity type, in proximity to the real estate property.

9. The method according to claim 6, wherein the amenity distance corresponds to an average of distances between a location of the real estate property and multiple instances, respectively, of said amenity type of the corresponding listing amenity.

10. The method according to claim 6, wherein said assigning a score further comprises:
providing distance brackets and associating a numerical score to each of said distance bracket; and
selecting the numerical score associated to the distance bracket which corresponds to said amenity distance.

11. The method according to claim 5, wherein said aggregating comprises associating a weight to the score of each listing amenity, on the basis of the importance indicia associated to the corresponding desired amenity.

12. The method according to claim 5, wherein said aggregating further comprises combining a human factor multiplier to obtain the ranking value.

13. The method according to claim 5, wherein said aggregating further comprises combining a neighborhood influencer multiplier to obtain the ranking value.

14. The method according to claim 11, wherein:
the importance indicia includes one of: High importance indicia (H), Moderate importance indicia (M) and Low importance indicia (L), and
said aggregating comprises applying the following equation for determining the ranking value:
Ranking value=
Math.Round (Average of High importance indicia scores
+Average of Moderate importance indicia scores×0.1
+Average of Low importance indicia scores×0.01, 2)
x Human Factor
x Neighborhood Influencer
where Human Factor is an average of ranking given by area experts, and Neighbourhood Influencer is a multiplier based on demographic and real estate.

15. The method according to claim 1, further comprising:
storing each ranking value in said memory in association with the corresponding listing and the corresponding demography profile.

16. The method according to claim 1, further comprising:
receiving, at the processor via an input port, a selected demography profile corresponding to a selection among said demography profiles, and a search query;
returning, by means of search engine integrated in said processor, result listings representing listings stored in the memory, which correspond to the search query;
ranking, by means of a ranking module integrated in the processor, said result listings based on said ranking value; and
selecting, by means of a selection module integrated in the processor, result listings to be output as output listings; and
sending via an output port, the output listings to be presented in accordance to said ranking.

17. The method according to claim 16, wherein the selecting comprises:
providing a ranking threshold; and
selecting result listings having a ranking value greater or equal to said ranking threshold.

18. The method according to claim 16, wherein said outputting comprises presenting the selected listings in a list, sorted according to the ranking value of each selected listing.

19. The method according to claim 16, wherein said outputting comprises presenting the selected listings in a map.

20. A non-transitory processor-readable storage medium for ranking real estate property listings, the processor-readable storage medium comprising data and instructions for execution by a processor, to execute the steps of the method, in accordance with claim 1.

21. A system for ranking real estate property listings, the system comprising:
a memory for storing:
listings, each representing a real estate property;
demography profiles, each representing a group of demography; and
amenity types;
wherein each listing and being is associated to one or more listing amenity selected among said amenity types, representing amenities present in proximity to the real estate property and wherein each demography profile is associated to one or more desired amenity selected among said amenity types representing amenities desired by the corresponding group of demography; and
a calculator integrated in a processor for calculating a ranking value for each listing, for one of said demography profiles, on the basis of a correspondence between the one or more desired amenity of the demography profile and the one or more listing amenity associated to the listing, in order to rank said listings for the corresponding group of demography.

22. A system according to claim 21, wherein the demography profiles stored in the memory comprise at least one of: a student profile, a young professional profile, a family-oriented profile and an empty nester profile.

23. A system according to claim 21, wherein each of said one or more desired amenity is stored in association with an importance indicia for a given one of said demography profiles, the importance indicia representing a level of importance of said desired amenity for the corresponding group of demography, in order to calculate the ranking value based on the importance indicia of the desired amenity associated to each listing amenity.

24. A system according to claim 21, wherein the memory further stores a human factor multiplier in association with one of said listings in order to be combined for calculating the ranking value.

25. A system according to claim 21, wherein the memory further stores a neighborhood influencer multiplier in association with one of said listings in order to be combined for calculating the ranking value.

26. A system according to claim 21, wherein the processor further comprises:
an input port, for receiving a selected demography profile corresponding to a selection among said demography profiles, and for receiving a search query;
a search engine for returning result listings representing listings stored in the memory, which correspond to the search query;
a ranking module for ranking said result listings based on said ranking value;
a selection module for selecting result listings to be output as output listings; and
an output port for sending the output listings to be presented in accordance to said ranking.
